(19) United States
(12) Patent Application Publication
(10) Pub. No.: US 2025/0129891 A1
(43) Pub. Date: Apr. 24, 2025

(54) METHODS AND SYSTEMS FOR STORING AND TRANSPORTING HYDROGEN IN ADSORBED CONDITION

(71) Applicant: NZT Group Inc., Dover, DE (US)

(72) Inventor: Zack Spencer, Dover, DE (US)

(21) Appl. No.: 18/922,013

(22) Filed: Oct. 21, 2024

Related U.S. Application Data
(60) Provisional application No. 63/545,092, filed on Oct. 20, 2023.

(51) Int. Cl. F17C 11/00

(52) U.S. Cl. CPC F17C 11/005; F17C 2205/0341; F17C 2221/012; F17C 2223/035; F17C 2270/0171

(57) ABSTRACT

In some implementations of principles according to the present disclosure, a device may include a vessel defining an internal storage volume for containing the pressurized hydrogen. In addition, the device may include a catalyst in communication with the internal storage volume and configured to engage hydrogen to be stored in the internal storage volume such that the hydrogen is compactly stored at a high energy density.

### CROSS-REFERENCE TO RELATED PATENT APPLICATIONS

The present application claims the benefit of priority to U.S. Provisional Patent Application No. 63/545,092, filed Oct. 20, 2023, which is incorporated herein by reference in its entirety.

### TECHNICAL FIELD

The present disclosure relates to the field of hydrogen storage and transportation. Specifically, it pertains to a novel method and system for safely storing and transporting hydrogen gas in an adsorbed condition within a pressure vessel.

### BACKGROUND

Hydrogen is a clean and efficient energy carrier, but its storage and transportation pose significant challenges due to its low density and high flammability. Existing methods rely on either high-pressure gas cylinders or cryogenic storage, each with its limitations in terms of safety and energy efficiency. The disclosure described herein aims to overcome these limitations by storing hydrogen in an adsorbed condition at moderate pressure within a specially designed pressure vessel.

### SUMMARY

The present disclosure discloses a method and system for the efficient storage and transportation of hydrogen gas. It utilizes an innovative pressure vessel design and adsorption technology to safely store hydrogen gas at high pressure while minimizing the risk of leakage and ensuring ease of transportation.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a schematic view of a vehicle-fueling application for pressure vessels made in accordance with principles of the present disclosure.

FIG. 2 is a graph of Base Hydrogen Results.

FIG. 3 is a graph of Pressure Vessel and Absorbent Results.

FIG. 4 is a graph comparing the tests in FIGS. 2 and 3.

While the disclosure is amenable to various modifications and alternative forms, specific examples have been shown by way of example in the drawings and are described in detail below. The intention, however, is not to limit the disclosure to the particular examples described. On the contrary, the disclosure is intended to cover all modifications, equivalents, and alternatives falling within the scope of the disclosure as defined by the appended claims.

### DETAILED DESCRIPTION

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings. It is not beyond the scope of this disclosure to have a number (e.g., all) the features in a given embodiment to be used across all embodiments.

Devices, systems, and methods disclosed herein involve the following components: a pressure vessel, an adsorbent material, a hydrogen storage structure, and a release mechanism. In examples, the pressure vessel is specially designed to withstand high pressures. The adsorbent material is carefully selected to adsorb hydrogen gas effectively. The hydrogen storage and release mechanism control the adsorption and desorption of hydrogen onto the adsorbent material. Hydrogen is a highly flammable and explosive gas, which requires careful handling and storage. One of the main challenges in hydrogen storage is to achieve high volumetric and gravimetric densities, e.g., to store as much hydrogen as possible in a given volume or weight, while ensuring safety and reliability.

Pressure vessels are typically containers designed to hold gases or liquids at high pressure. In the case of storing hydrogen, pressure vessels are used to hold hydrogen gas under high pressure. This is because hydrogen gas is a low-density gas, which means it needs to be compressed to fit into a small space. The pressure inside the vessel keeps the hydrogen in a liquid or gaseous state. The construction of pressure vessels for hydrogen storage involves using materials that are strong enough to withstand high pressures, such as carbon fiber composites or metal alloys. The vessel is designed to have a valve that allows for filling and releasing of hydrogen gas. The hydrogen is typically stored at pressures between 350 and 700 bar (e.g., about 5,000 psi and 10,000 psi). The use of pressure vessels for storing hydrogen is an important technology for the development of hydrogen fuel cell vehicles and other applications that require the use of hydrogen gas.

In examples, the pressure vessel is made of a high-strength, lightweight material capable of withstanding high pressures. Such materials can include carbon fiber. In addition, or in alternative, the material can include steel, especially where robustness is a top design consideration. The adsorbent material is chosen for its high hydrogen adsorption capacity and selectivity. Of course, it is useful for the adsorbent material to be readily available for implementation. In examples, hydrogen engages the adsorbent material at moderate pressure. In examples, hydrogen is released when needed for various applications, such as fuel cells or industrial processes.

Principles of the present disclosure are distinguished at least in the combination of a specially designed pressure vessel, a high-capacity adsorbent material, and an efficient hydrogen storage and release mechanism. Among their advantages, principles of the present disclosure allow for safe and high-density hydrogen storage, making it suitable for various applications. In addition, principles of the present disclosure provide the following advantages: enhanced safety through effective containment of hydrogen gas; improved energy density compared to traditional storage methods; greater control over hydrogen release for versatile applications; and reduced environmental impact by facilitating the use of hydrogen as a clean energy source.

The pressure vessels of the disclosure comprise a composite material that combines high strength, low weight, and resistance to fatigue and fracture. The composite material comprises a matrix of polymer resin reinforced with fibers of carbon, glass, or other suitable materials. The fibers are arranged in a specific pattern and orientation to provide optimal mechanical properties and hydrogen permeability. The pressure vessels of the disclosure can store hydrogen at high pressures, typically in the range of 700-1000 bar, with high efficiency and safety. Moreover, the pressure vessels of the disclosure can be designed and manufactured to meet specific requirements of size, shape, and performance, and can be easily integrated into existing hydrogen storage and transportation systems.

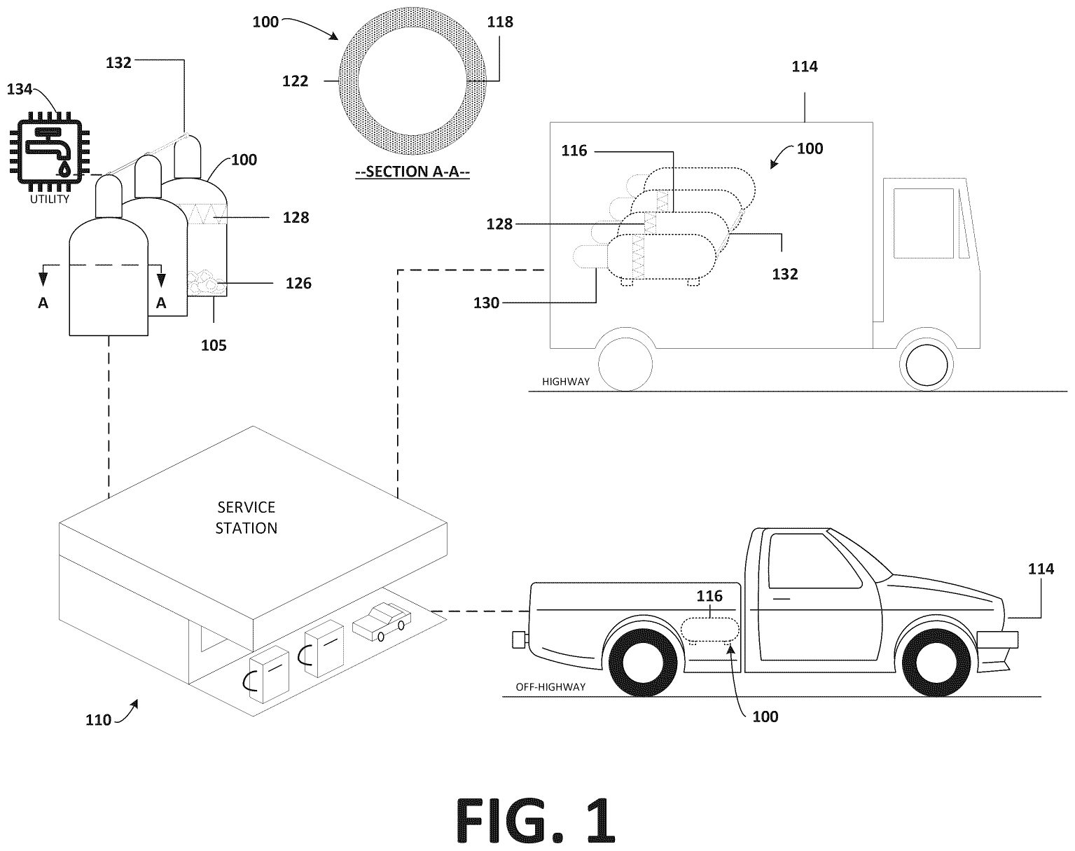

Turning now to FIG. 1, an exemplary application for pressure vessels 100 according to principles of the present disclosure is schematically illustrated. In this application, an alternative fuel, such as hydrogen, is stored at a stationary storage 105 of a service station 110, such as a home or commercial fueling station, for delivery from pressure vessels 100 to a vehicle 114 adapted to run on the alternative fuel. For conciseness, reference to alternative fuels here below may sometimes be referred to as hydrogen alone, but other alternative fuels, especially those capable of high-density storage via adsorption, are contemplated. Similarly, reference to storage or source may be referred to as one or the other, but it should be understood that certain applications may interchangeably or specifically accommodate a storage (e.g., for transport) or source (e.g., for powering a vehicle) depending on desired use. Section A-A shows how a liner 118 according to principles of the present disclosure can be arranged within a wall 122 of the pressure vessel 100, though other configurations (e.g., mesh, composite structure, deposits, and the like) are contemplated. For instance, the rightmost pressure vessel 100 in the stationary storage shows a particulate catalyst 126 stored in a filtered pressure vessel 100 (e.g., via filter 128) that permanently or removably entraps the catalyst 126 in the pressure vessel 100 for storage.

Hydrogen service methods can begin by having hydrogen service arrive via commercial infrastructure, similar to the type normally delivered to houses and businesses via a metered delivery point. A fluid line is run from stationary storage, which can serve as a delivery point, to a service station as needed. There may be dryers or other systems to remove excess moisture contained within the incoming hydrogen. In addition, a filter may be provided to remove impurities and/or to retain catalyst 126 in the storage or source. At this point, the hydrogen can be delivered to receiver 130 of storage or source and compressed as described elsewhere herein. This compressed gas is sent to the service station stored in intermittent and/or final storage tanks. At least one of the storage tanks contain hydrogen at a pressure sufficient to fuel a vehicle, such as 1,500 psi where the vehicle is designed to receive hydrogen at up to 600 or 1,000 psi. This is just one example of many examples disclosed herein. For instance, in addition or in alternative, hydrogen may be stored and delivered at similar pressures or store the hydrogen at a lower pressure than it is delivered. As

Hydrogen is delivered from the stationary storage to the vehicle at the service station via a dispenser that is couplable to a receiver of the onboard storage. The dispenser can use pressure differentials between stationary storage and onboard storage of the vehicle to allow hydrogen to flow into the vehicle at a desired rate and to a desired pressure before shutting off. The shut off can be automatic in some instances. Optionally, a terminal at the service station can meter the volume of hydrogen delivered for monitoring and/or payment. Such vehicles can be used in highway and/or off-highway applications.

A catalyst 126 in the onboard storage can store supplied hydrogen at a high density. For instance, the catalyst 126 can be an adsorber that adsorbs hydrogen in a manner of minutes (e.g., rather than hours). Hydrogen stored in the onboard storage can be supplied to the vehicle via desorption. In examples, the desorption process of hydrogen can occur at a slower rate than the adsorption process of hydrogen. Of course, there are examples where the opposite is true or where both processes occur at the same or similar rate. In examples, it may be helpful to configure the adsorption and/or desorption processes to be variable (e.g., sped up, recovered, or slowed down) by varying a temperature of the hydrogen. Similar configurations can be implemented at the stationary storage. When kept at a constant supply by utility 134, a catalyst 126 in the stationary storage can operate before, during and/or after a fueling operation to maintain a desired pressure in the stationary storage.

Any of the vehicles disclosed herein can facilitate safe, alternative transportation of hydrogen. Notably, these vehicles can be powered by fuel cells in zero-emission vehicles with fast filling times and high efficiency. In examples, these fuel cells can be coupled with an electric motor while still offering higher efficiency (e.g., 2 to 4 times) than that of a gasoline internal combustion engine. In addition, or in alternative, hydrogen can be used as fuel for hydrogen internal combustion engines. However, when compared to fuel cell electric vehicles, these hydrogen internal combustion engines can produce tailpipe emissions and are less efficient.

In more detail, the present disclosure relates to devices, systems, and methods for storing and/or transporting hydrogen. Using a catalyst 126, principles of the present disclosure include storing hydrogen in a compressed state (e.g., from a gaseous state to a fluid state). The catalyst 126 can be insertable via a structure (e.g., a liner for a vessel) and/or otherwise disposed within the vessel in a manner that contacts the hydrogen. In examples, storage systems can include a vessel defining an internal storage volume for containing the pressurized hydrogen. Storage systems can also include a catalyst 126 in communication with the internal storage volume and configured to engage hydrogen to be stored in the internal storage volume such that the hydrogen is compactly stored at a high energy density. The vessel may be refillable, single-use, and or serviceable (e.g., having a replaceable liner) as desired. For instance, two or more vessels can be connected via a common rail 132 that is configured to distribute (e.g., uniformly or collectively) supplied hydrogen among the vessels. Other embodiments of this aspect include corresponding computer systems, apparatus, and computer programs recorded on one or more computer storage devices, each configured to perform actions of related methods.

The described implementations can also include one or more of the following features. Storage systems where the hydrogen is stored at a moderate storage pressure. Such storage systems can include configurations where the moderate storage pressure is about or less than 10,000 psi. For instance, 1500 psi or thereabouts can be achievable. Such storage systems can include configurations where the moderate storage pressure is less than 1000 psi. Such storage systems can include configurations where the moderate storage pressure is about 600 psi. Such storage systems can include storage systems where the moderate storage pressure is between 15 psi and 600 psi. In any of these examples, the vessel can comprise metal and/or carbon fiber for weight savings. It is estimated that such storage systems can be about 2 feet diameter by 6 feet of tank. Therefore, it can be appreciated that these storage systems are portable in numerous applications.

In examples, the storage systems have a catalyst 126 that is an adsorbent. The adsorbent can be configured to adsorb the hydrogen at an adsorption rate that facilitates compact storage of the hydrogen at the high energy density. Such storage systems can include configurations where the adsorption rate and an arrangement of the adsorbent at the vessel is such that the hydrogen is stored at or around the high energy density as the hydrogen enters the internal storage volume. In examples, the storage systems can have enough absorbent (e.g., as determined by a ratio of the adsorbent to a fill level of the internal storage volume) to saturate the adsorbent (e.g., to a maximum or near maximum saturation point of the adsorbent). Under such or similar circumstances, adsorption hysteresis can be minimized. As discussed further below, the storage systems can have one or more adsorbents, such as graphene, aerogels, activated carbon, and the like. Storage systems can include a screen having a filter sized to capture particulates of the graphene. Implementations of the described techniques can include hardware, a method or process, or a computer tangible medium.

As noted above, some implementations herein relate to a structure for insertion into a storage system. For instance, the structure can be a liner (or lining) of a vessel. The liner may be replaceable and/or able to perform similar across multiple fills of the vessel. For example, the liner can include a liner body that is configured to be received by the hydrogen pressure vessel 100 so as to be in fluid communication with the hydrogen in an internal storage volume of the hydrogen pressure vessel 100. The liner can also include a catalyst 126 stored at the liner body (e.g., in or around or otherwise adjoining structure of the liner body). This liner can be arranged within a vessel to engage the hydrogen when stored in the internal storage volume. The catalyst 126 can be configured to adsorb the hydrogen for storage in the hydrogen pressure vessel 100 at a high energy density and at a moderate storage pressure as discussed elsewhere herein. Other embodiments of this aspect include corresponding computer systems, apparatus, and computer programs recorded on one or more computer storage devices, each configured to perform related methods.

In addition, or in alternative, the described implementations can include one or more of the following features. Liner where the catalyst 126 is an adsorbent that can include at least one graphene lattice layer that is configured for hydrogen capture to thereby achieve the high energy density. Liner where the liner is sized such that the adsorbent has an adsorption rate that corresponds to saturation of the adsorbent while the hydrogen pressure vessel 100 nears or is filled. Liner where the liner is configured to adsorb gaseous hydrogen such that fluid hydrogen is stored in the hydrogen pressure vessel 100. Implementations of the described techniques can include hardware, a method or process, or a computer tangible medium.

Some implementations herein relate to an onboard storage system for transporting hydrogen and/or onboard storage systems for use in a hydrogen powered (e.g., fuel cell or hydrogen internal combustion engine) vehicle. For example, onboard hydrogen storage systems can include at least one pressure vessel 100 having a vessel wall defining an internal storage volume for receiving hydrogen to be stored by the pressure vessel 100. The storage systems can include a receiver in communication with the internal storage volume. The receiver can be configured to receive supplied hydrogen and direct it toward the internal storage volume. Such onboard hydrogen storage systems can include a catalyst 126 in communication with the internal storage volume. In this regard, the catalyst 126 (or related structure) can be configured to engage the hydrogen to be stored in the internal storage volume such that the hydrogen is compactly stored at a high energy density and at a moderate storage pressure. Other embodiments of this aspect include corresponding computer systems, apparatus, and computer programs recorded on one or more computer storage devices, each configured to perform related methods.

In addition, or in alternative, the described implementations can include one or more of the following features. For instance, the vehicle can be configured to provide hydrogen for vehicle operations of the vehicle, and the vehicle can have a hydrogen storage system that is separate from a fuel source of the vehicle (e.g., a hydrogen storage that provides hydrogen for vehicle operations of the vehicle). In examples, onboard hydrogen storage systems include configurations where the hydrogen is stored at least at 15 times an ambient temperature density of hydrogen. In some examples, this value is at least 17 times the ambient temperature density of hydrogen. Onboard hydrogen storage systems can include a receiver that is configured to couple to a low- or moderate-pressure pump that is configured to supply the onboard hydrogen storage systems with hydrogen. Supplied hydrogen can be at a pressure not to exceed about 1500 psi. Implementations of the described techniques can include hardware, a method or process, or a computer tangible medium with related methods.

### WORKING EXAMPLE(S)

Preliminary experiments that implement principles of the present disclosure have demonstrated the effectiveness thereof in safely storing and releasing hydrogen gas at moderate pressures. These experiments have used pressure vessels with a graphene adsorbent that is derived from biomass. These experiments validate the concept and its potential for commercial use. Some tested adsorbents have shown as much as 17 times increase in hydrogen storage at an equivalent pressure of 600 psi compared with carbon natural gas hydrogen.

### Base Hydrogen Testing

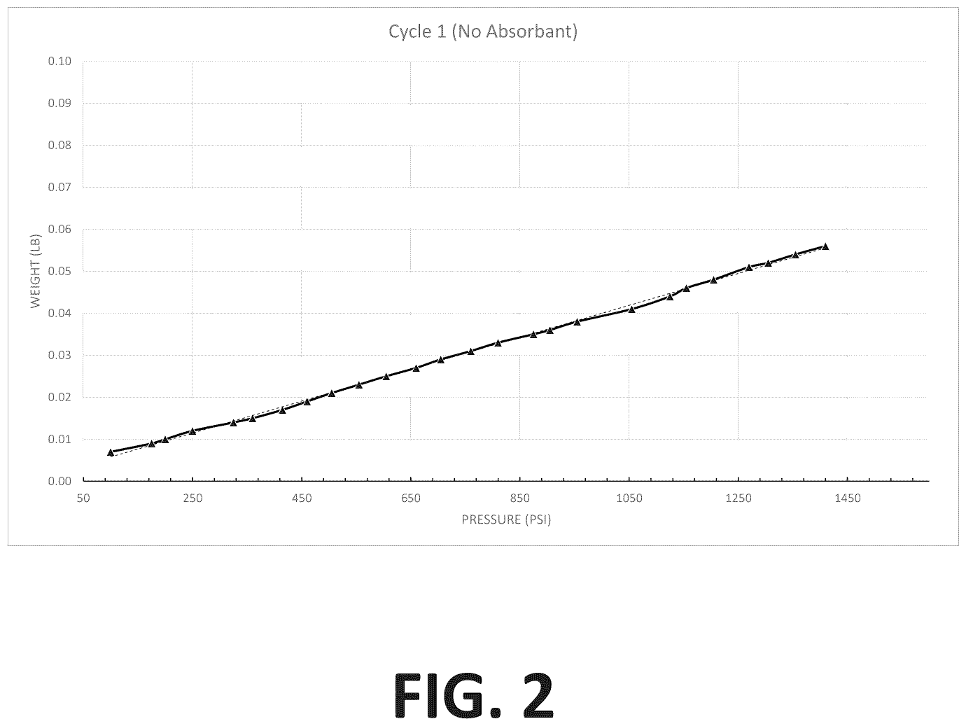

FIG. 2 is a graph of the results in Table 1 below. Hydrogen stored in gas cylinders in its raw state exhibits a high weight-to-pressure ratio, which poses limitations on the energy efficiency of current storage methods. Data indicates a linear relationship between pressure and weight; as pressure increases, so does the weight of the stored hydrogen. This underscores the need for improved storage solutions that enhance efficiency while minimizing weight.

TABLE 1
Base Hydrogen Test Results

| Pressure | Units | Weight | Units |
|---|---|---|---|
| 100 | Psi | 0.007 | lbs |
| 175 | Psi | 0.009 | lbs |
| 200 | Psi | 0.010 | lbs |
| 250 | Psi | 0.012 | lbs |
| 325 | Psi | 0.014 | lbs |
| 360 | Psi | 0.015 | lbs |
| 415 | Psi | 0.017 | lbs |
| 460 | Psi | 0.019 | lbs |
| 505 | Psi | 0.021 | lbs |
| 555 | Psi | 0.023 | lbs |
| 605 | Psi | 0.025 | lbs |
| 660 | Psi | 0.027 | lbs |
| 705 | Psi | 0.029 | lbs |
| 760 | Psi | 0.031 | lbs |
| 810 | Psi | 0.033 | lbs |
| 875 | Psi | 0.035 | lbs |
| 905 | Psi | 0.036 | lbs |
| 955 | Psi | 0.038 | lbs |
| 1055 | Psi | 0.041 | lbs |
| 1125 | Psi | 0.044 | lbs |
| 1155 | Psi | 0.046 | lbs |
| 1205 | Psi | 0.048 | lbs |
| 1270 | Psi | 0.051 | lbs |
| 1305 | Psi | 0.052 | lbs |
| 1355 | Psi | 0.054 | lbs |
| 1410 | psi | 0.056 | lbs |

### Absorbent Testing

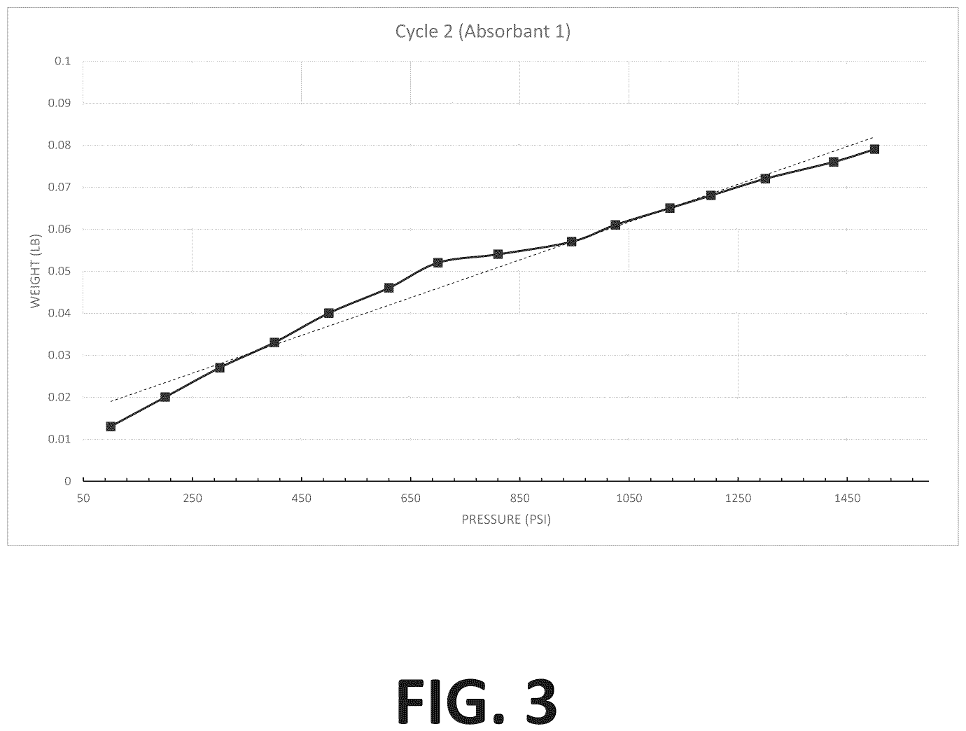

FIG. 3 is a graph of the results in Table 2 below. This disclosure includes the use of specifically designed pressure vessels in conjunction with optimized absorption materials to increase the absorption weight of hydrogen while maintaining lower pressures. This approach enables the storage of a greater mass of hydrogen at reduced pressure levels, enhancing overall efficiency and safety in hydrogen storage systems. By leveraging advanced absorption materials, this method aims to maximize hydrogen capacity without compromising structural integrity or operational effectiveness.

TABLE 2
Pressure Vessel and Absorbent

| Pressure | Units | Weight | Units |
|---|---|---|---|
| 100 | Psi | 0.013 | lbs |
| 200 | Psi | 0.020 | lbs |
| 300 | Psi | 0.027 | lbs |
| 400 | Psi | 0.033 | lbs |
| 500 | Psi | 0.040 | lbs |
| 610 | Psi | 0.046 | lbs |
| 700 | Psi | 0.052 | lbs |
| 810 | Psi | 0.054 | lbs |
| 945 | Psi | 0.057 | lbs |
| 1025 | Psi | 0.061 | lbs |
| 1125 | Psi | 0.065 | lbs |
| 1200 | Psi | 0.068 | lbs |
| 1300 | Psi | 0.072 | lbs |
| 1425 | Psi | 0.076 | lbs |
| 1500 | Psi | 0.079 | lbs |

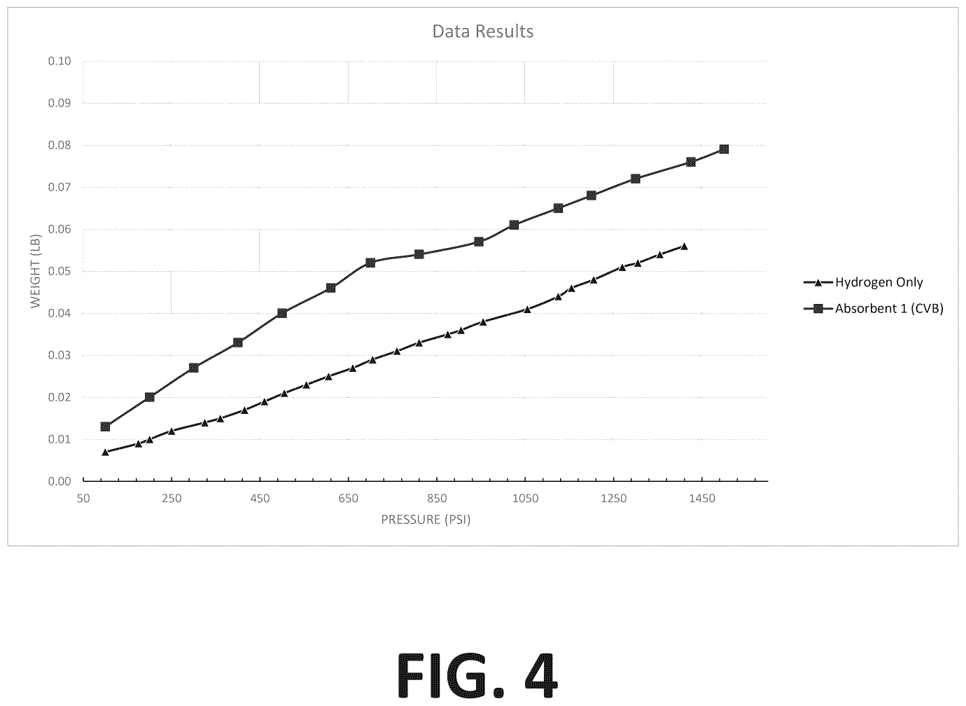

FIG. 4 is a graph comparing the results from Tables 1 and 2, and correspondingly FIGS. 2 and 3. This comparison of the data reveals that the weight of hydrogen stored in the specifically designed pressure vessel with optimized absorbent materials consistently increases at each individual pressure point when compared to traditional storage of pure hydrogen. This demonstrates the enhanced capacity for hydrogen retention facilitated by the innovative combination of the pressure vessel and absorbent materials, highlighting a significant improvement in storage efficiency across various pressure levels.

Note that included within the scope of this disclosure are methods corresponding to any of the devices, systems, and processes disclosed herein. For instance, disclosed herein are methods for storing and transporting pressurized hydrogen. Optionally, such methods can include providing a vessel that defines an internal storage volume for containing the pressurized hydrogen. Such methods can include introducing hydrogen into the internal storage volume. Such methods can include engaging a catalyst in communication with the internal storage volume to interact with the hydrogen. In this results any of these steps can facilitate enabling the hydrogen to be compactly stored at a high energy density within the vessel.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is:

1. A storage system for storing and transporting pressurized hydrogen, the storage system comprising:
a vessel defining an internal storage volume for containing the pressurized hydrogen; and
a catalyst in communication with the internal storage volume and configured to engage hydrogen to be stored in the internal storage volume such that the hydrogen is compactly stored at a high energy density.

2. The storage system of claim 1, wherein the hydrogen is stored at a moderate storage pressure.

3. The storage system of claim 2, wherein the moderate storage pressure is less than 1500 psi.

4. The storage system of claim 3, wherein the moderate storage pressure is less than 10,000 psi.

5. The storage system of claim 2, wherein the moderate storage pressure is about 600 psi.

6. The storage system of claim 2, wherein the moderate storage pressure is between 15 psi and 600 psi.

7. The storage system of claim 1, wherein the catalyst is an adsorbent that is configured to adsorb the hydrogen at an adsorption rate that facilitates compact storage of the hydrogen at the high energy density.

8. The storage system of claim 7, wherein the adsorption rate and an arrangement of the adsorbent at the vessel is such that the hydrogen is stored at or around the high energy density as the hydrogen enters the internal storage volume.

9. The storage system of claim 7, wherein a ratio of the adsorbent to a fill level of the internal storage volume corresponds to a saturation point of the adsorbent so as to minimize adsorption hysteresis.

10. The storage system of claim 7, wherein the adsorbent comprises graphene.

11. The storage system of claim 10, further comprising a screen having a filter sized to capture particulates of the graphene.

12. A liner for a hydrogen pressure vessel that is configured to compactly contain hydrogen, the liner comprising:
a liner body that is configured to be received by the hydrogen pressure vessel so as to be in fluid communication with the hydrogen in an internal storage volume of the hydrogen pressure vessel; and
a catalyst stored in the liner body so as to engage the hydrogen when stored in the internal storage volume, the catalyst being configured to adsorb the hydrogen for storage in the hydrogen pressure vessel at a high energy density and at a moderate storage pressure.

13. The liner of claim 12, wherein the catalyst is an adsorbent that comprises at least one graphene lattice layer that is configured for hydrogen capture to thereby achieve the high energy density.

14. The liner of claim 12, wherein the liner is configured to adsorb gaseous hydrogen within an interior wall defining a portion of the interior of the pressure vessel such that fluid hydrogen is stored in the hydrogen pressure vessel.

15. The liner of claim 13, wherein the liner is sized such that the adsorbent has an adsorption rate that corresponds to saturation of the adsorbent while the hydrogen pressure vessel nears or is filled.

16. An onboard hydrogen storage system, comprising:
at least one pressure vessel having a vessel wall defining an internal storage volume for receiving hydrogen to be stored by the pressure vessel and a receiver in communication with the internal storage volume and configured to reverting the hydrogen; and
a catalyst in communication with the internal storage volume and configured to engage the hydrogen to be stored in the internal storage volume such that the hydrogen is compactly stored at a high energy density and at a moderate storage pressure.

17. A vehicle having the onboard hydrogen storage system of claim 16 to provide hydrogen for vehicle operations of the vehicle.

18. A vehicle having the onboard hydrogen storage system of claim 16 that is separate from a hydrogen storage that provides hydrogen for vehicle operations of the vehicle.

19. The onboard hydrogen storage system of claim 16, wherein the hydrogen is stored at least at 15 times an ambient temperature density of hydrogen.

20. The onboard hydrogen storage system of claim 16, wherein the receiver is configured to couple to a moderate-pressure pump that is configured to supply the onboard hydrogen storage system with hydrogen at a pressure not to exceed about 10,000 psi.
